(19) United States
(12) Patent Application Publication
(10) Pub. No.: US 2022/0135841 A1
(43) Pub. Date: May 5, 2022

(54) LUBRICIOUS COATINGS FOR SKIS AND SNOWBOARDS AND RELATED SYSTEMS AND METHODS OF USE

(71) Applicant: Drake Powderworks, LLC, Salt Lake City, UT (US)

(72) Inventors: Jeffrey Scott Bates, Bountiful, UT (US); Dennis Schmidt Pruzan, Salt Lake City, UT (US); Kelan Albertson, Boise, ID (US); Charles Schayer, Salt Lake City, UT (US); Stephan Drake, Salt Lake City, UT (US); Thomas Laakso, Park City, UT (US)

(21) Appl. No.: 17/432,629

(22) PCT Filed: Feb. 19, 2020
(86) PCT No.: PCT/US2020/018825

§ 371 Date: Aug. 20, 2021

Related U.S. Application Data
(60) Provisional application No. 62/808,084, filed on Feb. 20, 2019.

(51) Int. Cl. C09G 3/00; C10M 107/50; C10M 107/38; B05D 3/06; B05D 3/02; B05C 15/00

(52) U.S. Cl. CPC C09G 3/00; C10M 107/50; C10M 107/38; B05D 3/067; C10N 2050/02; B05C 15/00; C10M 2229/0515; C10M 2213/0623; B05D 3/0254

(57) ABSTRACT

Coatings, coating systems and coating methods for skis and snowboards are provided. The coatings may be lubricious coatings including one or more hydrophobic compounds, adhesion agents, shape memory polymers, free-radical initiators, and/or carrying solvents.

### RELATED APPLICATIONS

This application claims priority to U.S. Provisional Application No. 62/808,084 filed on Feb. 20, 2019 and titled “LUBRICIOUS COATINGS FOR SKIS AND SNOWBOARDS AND RELATED SYSTEMS AND METHODS OF USE,” which is hereby incorporated by reference in its entirety.

### TECHNICAL FIELD

The present disclosure relates generally to lubricious coatings. The coatings may be applied to the base material of skis and snowboards. More specifically, the present disclosure relates to lubricious coatings including one or more adhesion agents, hydrophobic compounds, shape memory polymers, free-radical initiators, and/or carrying solvents. Related methods are also disclosed.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a perspective view of a closed light box for initiating a grafting reaction of the ski and snowboard base coating compositions described herein.

FIG. 2 is a perspective view of the light box of FIG. 1 with a pair of skis disposed therein.

### DETAILED DESCRIPTION

The components of the embodiments as generally described and illustrated herein can be arranged and designed in a wide variety of different configurations. Thus, the following more detailed description of various embodiments is not intended to limit the scope of the present disclosure, but is merely representative of various embodiments. It will be appreciated that various features are sometimes grouped together in a single embodiment or description thereof for the purpose of streamlining the disclosure. Many of these features may be used alone and/or in combination with one another.

Embodiments may be understood by reference to the drawings, wherein like parts are designated by like numerals throughout. It will be readily understood by one of ordinary skill in the art having the benefit of this disclosure that the components of the embodiments, as generally described and illustrated in the figures herein, could be arranged and designed in a wide variety of different configurations. Thus, the following more detailed description of various embodiments, as represented in the figures, is not intended to limit the scope of the disclosure, but is merely representative of various embodiments. While the various aspects of the embodiments are presented in drawings, the drawings are not necessarily drawn to scale unless specifically indicated.

Skis and snowboards are generally used for gliding on snow. A ski or a snowboard may include a coating that imparts one or more characteristics or properties to the ski or the snowboard. For example, the coating can be applied to the base of the ski or the snowboard to affect, among other properties or characteristics, a level of friction between the ski or the snowboard and snow (e.g., during forward motion). Some coatings may be configured to reduce the level of friction. Some other coatings may be configured to increase the level of friction (e.g., the coatings may be applied for increased grip between the ski or snowboard and snow).

The terms “lubricious” and “lubricity,” as used herein, refer to the characteristic of being smooth or slippery, or of possessing a low coefficient of friction. Higher levels of lubricity correspond to lower coefficients of friction, and lower levels of lubricity correspond to higher coefficients of friction.

The term “coating,” as used herein, refers to a layer or layers of material that have been applied to a surface of a ski or snowboard. A coating may create a distinct layer over a base substrate. However, as described herein, a coating may form an interpenetrating network where the boundaries between the coating layer and base substrate are less distinct due to overlap between the coating and the base substrate. As detailed below, the coatings disclosed herein may include one or more hydrophobic compounds, adhesion agents, shape memory polymers, free-radical initiators, antistatic agents, and/or carrying solvents.

The term “adhesion agent,” as used herein, refers to an additive that promotes the adhesion of a coating to the substrate of interest (e.g., a surface of a ski or snowboard) and has an affinity for the substrate and the applied coating.

The term “shape memory polymer,” as used herein, refers to an additive that has the ability to return from a deformed state to its original state when induced by an external stimulus (e.g., temperature, light, etc.). Shape memory polymers may be used as a thermal stabilizer for the coating compositions described herein.

In some embodiments, a coating of the present disclosure may be used for a ski or snowboard. For example, the coating may be applied to or disposed on at least a portion of a surface (e.g., a base surface) of a ski or a snowboard. A base of an uncoated or untreated ski or snowboard may be formed from ultra-high molecular weight polyethylene (UHMWPE). Other polyethylenes or polymers can also be used to form the base of a ski or snowboard. The coating may be a lubricious coating system for application to, or treatment of, a ski or snowboard. For example, the lubricity of a surface of a ski or snowboard that has been treated with the coating may be altered. Additionally, the coating may be a permanent, or substantially permanent, coating for a ski or snowboard.

Exemplary lubricious coatings described herein may create an interpenetrating polymer network with the base substrate. Such coating components may include a hydrophobic compound, an adhesion agent, a shape memory polymer, a free-radical initiator, and a carrying solvent. Furthermore, such coating components may include a hydrophobic compound, an adhesion agent, a shape memory polymer, a free-radical initiator, a carrying solvent, a catalyst, a water carrying agent, an antioxidant, and a surfactant. Two or more of these coating components may be present in an exemplary composition, as well as any permutations, combinations, or subcombinations thereof.

The coating compositions and systems may comprise hydrophobic compounds that can affect a level of lubricity of the coating. For example, one or more hydrophobic compounds in the coating may impart enhanced lubricity to a surface of a ski or snowboard that is treated with the coating. In some embodiments, the one or more hydrophobic compounds may include hydrophobic compounds that may be partially fluorinated, completely fluorinated, or a combination thereof. Exemplary hydrophobic compounds that may be used include, but are not limited to, fluorinated silanes, fluorinated hydrocarbons, fluorinated polymers, fluorinated silicones, hydrophobic non-fluorinated silanes, or combinations thereof. Other suitable fluorinated compounds are also within the scope of this disclosure. In various embodiments, the fluorinated compound may be a compound with fluorinated carbon side chains. Exemplary lengths of the fluorinated carbon side chains may be between about 1 and about 30 carbons. For example, the length of the fluorinated carbon side chain of the fluorinated compound may be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbons.

In certain embodiments, the coating may include a bi-modal distribution of two lengths of carbon side chains such that the lubricity of the coating is effective in both warm and cold temperatures. For example, the coating may be effective in a range of between about 0 and about 40 degrees Fahrenheit. In some embodiments, the hydrophobic compound may include a mixture of a first fluorinated silane including a first carbon side chain and a second fluorinated silane including a second carbon side chain, wherein the length of the first carbon side chain is greater than the length of the second carbon side chain. For example, the fluorinated compound may include a first fluorinated silane having a 1- to 8-carbon side chain (or a 1- to 5-carbon side chain) and a second fluorinated silane having a 9- to 30-carbon side chain (or a 9- to 18-carbon side chain). Other combinations of carbon side chain lengths are also within the scope of this disclosure. In certain embodiments, the fluorinated compound may include a mixture of three, four, five, or more fluorinated silanes having different carbon side chain lengths. Alternatively, a fluorinated compound may have more than one carbon side chain with different carbon side chain lengths within the same molecule. In some other embodiments, the coating may include a single length of fluorinated carbon side chains. For example, the fluorinated compound may include a fluorinated silane having a 3- to 20-carbon side chain (or a 5- to 18-carbon side chain).

In various embodiments, the fluorinated compound may be a fluorinated polymer. For example, the fluorinated polymer may be polytetrafluoroethylene (PTFE) or fluorinated ethylene propylene (FEP). Other suitable fluorinated polymers are also within the scope of this disclosure. In other embodiments, the hydrophobic compound may include a non-fluorinated silane compound. For example, the non-fluorinated silane compound may be methylated silane, methyl-siloxanyl silane, linear alkyl silane, dialkyl silane, branched alkyl silane, cyclic alkyl silane, phenyl silane, phenyl alkyl silane, substituted phenyl silane, substituted phenylalkyl silane, or napthyl-silane. Other suitable non-fluorinated polymers are also within the scope of this disclosure.

The amount of hydrophobic compounds that are present in the coating composition can be between about 0.1 and about 15 weight percent of the coating composition. Alternatively, the hydrophobic compounds may be present in an amount of between about 1.0 and about 15 weight percent, or about 2.0 and about 12.5 weight percent of the coating composition.

In some embodiments, the coating may include one or more adhesion agents or promoters and one or more hydrophobic compounds. The adhesion agent can aid in adhering, binding, and/or coupling the coating to at least a portion of a surface of a ski or snowboard. For example, the adhesion agent may chemically bind (e.g., via free radical initiators) to a portion of the surface of a ski or snowboard (e.g., a UHMWPE substrate) and provide an anchor for the hydrophobic compound. In certain embodiments, the adhesion agent may be a crosslinker. For example, upon addition of the one or more adhesion agents to a portion of the surface of a ski or snowboard the adhesion agents may promote crosslinking of the polymeric material forming a base material of the ski or snowboard. Such crosslinking can impart increased hardness and/or other desirable mechanical properties to the base material of the ski or snowboard.

Exemplary adhesion agents that may be used include, but are not limited to, organosilanes, hexachlorodisilane, poly(4-vinylphenol), polyacrylic acids, titanates, zirconates, or combinations thereof. Other suitable adhesion agents are also within the scope of this disclosure. In certain embodiments, the adhesion agent may be an organosilane. Exemplary organosilanes that may be used include, but are not limited to, vinyltrimethoxysilane, (3-aminopropyl)triethoxysilane, methyltrichlorosilane, triethoxymethylsilane, trimethoxymethylsilane, dimethoxydimethylsilane, methoxytrimethylsilane, diethoxydimethylsilane, triethoxyvinylsilane, trichlorovinylsilane, methyldiethoxysilane, triethoxy(ethyl)silane, ethoxytrimethylsilane, dimethoxyvinylsilane, ted-butyltrichlorosilane, (chloromethyl)triethoxysilane, bis(trichlorosilyl)methane, 1,2-bis(triethoxysilyl)ethane, 1,2-bis(trimethoxysilyl)ethane, 1,2-bis(trichlorosilyl)ethane, trichloro(dichloromethyl)silane, diethoxy(methyl)vinylsilane, 1,3-diethoxy-1,1,3,3-tetramethyldisiloxane, or combinations thereof. In some embodiments, the adhesion agent may be any silane with an amino functional group (e.g., aminopropyltrimethoxysilane, aminopropyltriethoxysilane, etc.) or a vinyl functional group (e.g., vinyltrimethoxysilane, vinyltriethoxysilane, etc.). Other suitable organosilanes are also within the scope of this disclosure.

The amount of adhesion agent that is present in the coating composition can be between about 0.1 and about 15 weight percent of the coating composition. Alternatively, the adhesion agent may be present in an amount of between about 1.5 and about 15 weight percent, or between about 3.5 and about 11 weight percent of the coating composition.

In various embodiments, the coating compositions and systems may comprise bi-functional compounds that may include both a hydrophobic functional group or moiety and an adhesion promoter functional group or moiety. For example, a bi-functional compound in the coating may affect a level of lubricity of the coating (i.e., due to the hydrophobic functional group or moiety) and the bi-functional compound in the coating may also aid in adhering, binding, and/or coupling the coating to at least a portion of a surface of a ski or snowboard (i.e., due to the adhesion promoter functional group or moiety). Exemplary bi-functional compounds that may be used include, but are not limited to, 1,6-divinylperfluorohexane, 1,4-divinylperfluorobutane, 1,8-divinylperfluorooctane, or combinations thereof. Other suitable bi-functional compounds are also within the scope of this disclosure. In some embodiments, 1,6-divinylperfluorohexane includes vinyl end groups that can promote adhesion and/or crosslinking and a fluorinated backbone that can impart hydrophobicity.

The coating may also include one or more shape memory polymers or stabilizers. The shape memory polymer may affect performance stability of the coating, for example, across a range of temperatures. In some embodiments, the coating may include a hydrophobic compound, an adhesion agent, and a shape memory polymer. Exemplary shape memory polymers that may be used include, but are not limited to, ε-caprolactone, polycaprolactone (PCL), polynorbomene, polyenes, nylons, polycyclooctene (PCO), polyvinyl acetate/polyvinylidene fluoride (PVAc/PVDF), PVAc/PVDF/poly-methylmethacrylate (PMMA) blends, polyurethanes, styrene-butadiene copolymers, polyethylene (PE), trans-isoprene, polyvinyl chloride (PVC), or combinations thereof. Other suitable shape memory polymers are also within the scope of this disclosure.

The amount of shape memory polymers that are present in the coating composition can be between about 1.0 and about 10 weight percent of the coating composition. Alternatively, the shape memory polymers may be present in an amount of between about 2.0 and about 7.5 weight percent of the coating composition.

The coating may also include one or more free-radical initiators. The free-radical initiator may aid in a free-radical initiated grafting reaction of at least a portion of the coating. In various embodiments, the free-radical initiator may induce coupling or “grafting” of the adhesion agent to the surface of the ski or snowboard, which can then crosslink the material forming the surface of the ski or snowboard (e.g., UHMWPE) following a moisture curing step or any other suitable curing step. In some embodiments, the coating may include a hydrophobic compound, an adhesion agent, and a free-radical initiator. The coating may also include a hydrophobic compound, an adhesion agent, a shape memory polymer, and a free-radical initiator. Exemplary free-radical initiators that may be used include, but are not limited to, photoinitiators, thermal initiators, chemical catalysts, or combinations thereof. Other suitable free-radical initiators are also within the scope of this disclosure.

In certain embodiments, the free-radical initiator may be a photoinitiator. The photoinitiators may include, but are not limited to, benzoin ethers, benzil ketals, α-dialkoxy-aceto-phenones, α-hydroxy-alkyl-phenones, α-aminoalkyl-phenones, acyl-phosphine oxides, benzo-phenones/amines, thio-xanthones/amines, titanocenes, or combinations thereof. Exemplary photoinitiators that may be used include, but are not limited to, acetophenone, anisoin, anthraquinone, anthraquinone-2-sulfonic acid (e.g., anthraquinone-2-sulfonic acid, sodium salt monohydrate), (benzene)tricarbonylchromium, benzil, benzoin, benzoin ethyl ether, benzoin isobutyl ether, benzoin methyl ether, benzophenone, benzophenone/1-hydroxycyclohexyl phenyl ketone (e.g., 50/50 blend), 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(II) hexafluorophosphate, dibenzosuberenone, 2,2-diethoxyacetophenone, 4,4′ dihydroxybenzophenone, dimethoxyacetophenone, 2,2-dimethoxy-2-phenylacetophenone (DMPAP), 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone (e.g., 50/50 blend), 4′-ethoxyacetophenone, 2-ethylanthraquinone, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, phenylbis (2,4,6-trimethylbenzoyl)-phosphine oxide (BAPO), thioxanthen-9-one, triarylsulfonium hexafluoroantimonate salts (e.g., mixed, 50% in propylene carbonate), thioxanthone, triarylsulfonium hexafluorophosphate salts (e.g., mixed, 50% in propylene carbonate), xanthone, or combinations thereof. Other suitable photoinitiators are also within the scope of this disclosure.

In various embodiments, the free-radical initiator may be a thermal initiator. The thermal initiators may include, but are not limited to, tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, or combinations thereof. Other suitable thermal initiators are also within the scope of this disclosure.

The amount of free-radical initiators that are present in the coating composition can be between about 0.01 and about 20 weight percent of the coating composition. Alternatively, the free-radical initiators may be present in an amount of between about 0.01 and about 10 weight percent of the coating composition, between about 0.02 and about 10 weight percent of the coating composition, or between about 0.5 and about 5 weight percent of the coating composition.

The coating may also include one or more carrying solvents. For example, the coating may include a hydrophobic compound, an adhesion agent, and a carrying solvent. In some embodiments, the coating may include a hydrophobic compound, an adhesion agent, a shape memory polymer, and a carrying solvent. In yet other embodiments, the coating may include a hydrophobic compound, an adhesion agent, a free-radical initiator, and a carrying solvent. Moreover, in certain embodiments, the coating may include at least one of a hydrophobic compound, an adhesion agent, a shape memory polymer, a free-radical initiator, and/or a carrying solvent. Exemplary carrying solvents that may be used include, but are not limited to, water, methanol, ethanol, ethylene glycol, propylene glycol, polyols, polar aprotic solvents, hydrocarbon solvents (aliphatic or aromatic), amine-based solvents, non-polar solvents (e.g., anisole) or combinations thereof. In some embodiments, the polyols may include 5 or fewer carbons. For example, the polyols may include, but are not limited to, 1,3-propanediol, polyethylene glycol (PEG), or combinations thereof. Exemplary polar aprotic solvents that may be used include, but are not limited to, acetone, dimethylformamide (DMF), acetonitrile, dimethyl sulfoxide (DMSO), dichloromethane, tetrahydrofuran (THF), ethyl acetate, hexamethylphosphoric triamide (HMPT), or combinations thereof. Other suitable carrying solvents that promote the miscibility of the polymer components and the polymeric substrate (e.g., ski or snowboard base) are also within the scope of this disclosure.

The amount of carrying solvent that is present in the coating composition can be between about 25 and about 95 weight percent of the coating composition. Alternatively, the carrying solvent may be present in an amount of between about 40 and about 80 weight percent of the coating composition or between about 60 and about 70 weight percent of the coating composition.

The coating may also include one or more catalysts. The catalysts may be used to accelerate the process of moisture curing or water curing a fluorinated silane or a non-fluorinated silane to form a fluorinated silicone or a non-fluorinated silicone. In some embodiments, the fluorinated compound may be a fluorinated silane. Accordingly, the fluorinated silane may be moisture cured to form a fluorinated silicone. For example, the fluorinated silane may undergo hydrolysis to form a fluorinated silanol and the fluorinated silanol may then undergo condensation to form a fluorinated silicone. The moisture curing process can be pH dependent. As such, exemplary catalysts that may be used include, but are not limited to, pH modifiers (e.g., acids or bases) such as acetic acid, hydrochloric acid, p-toluenesolufonic acid, ammonia water, sodium hydroxide, monoisopropanolamine, diisopropanolamine, triisopropanolamine, or combinations thereof.

The pH modifiers may control the hydrolysis and/or the condensation reactions. Other catalysts may also be used to control the hydrolysis and/or the condensation reactions including, for example, dibutyltin dilaurate, dibutyl bis(acetylacetonate), or combinations thereof. In some embodiments, catalysts such as dibutyltin dilaurate may enhance reactions between the adhesion agent and the polymeric substrate (e.g., ski or snowboard base). Other suitable catalysts are also within the scope of this disclosure. In some other embodiments, the pH modifier can act as an inhibitor. The pH modifiers can act as a catalyst at certain pH levels to enhance or increase the rate of conversion of hydrophobic silanes to hydrophobic silanols and of hydrophobic silanols to hydrophobic silicones. However, pH modifiers may also act to minimize the conversion of hydrophobic silanes to hydrophobic silanols and of hydrophobic silanols to hydrophobic silicones. Stated another way, the pH modifiers may act as an inhibitor. These processes (i.e., enhancing or inhibiting) can have different pH optimums. In certain embodiments, a pH modifier may be used to accelerate or enhance curing (e.g., for quick curing). In certain other embodiments, a pH modifier may be used to inhibit or minimize curing. For example, inhibition of curing may increase or maximize the shelf life of the coating system or composition (e.g., the pH modifier may limit or prevent curing of the coating system or composition before it is obtained by a user, technician, or manufacturer).

The coating may also include one or more water carrying agents. The water carrying agents may be used to aid or enhance the moisture curing process. Exemplary water carrying agents that may be used include, but are not limited to, calcium oxalate hydrate, calcium chloride hydrate, sodium carbonate hydrate, aluminum potassium sulfate dodecahydrate (alum), or combinations thereof. Other suitable water carrying agents are also within the scope of this disclosure.

The coating may also include one or more antioxidants. The antioxidant may scavenge free radicals. For example, the antioxidant can scavenge free radicals that may be generated by the one or more photoinitiators. Scavenging of the free radicals can limit or prevent oxidation of the material used to form the base of a ski or snowboard (e.g., polyethylene). In some embodiments, the coating may include a hydrophobic compound, an adhesion agent, a free-radical initiator, and an antioxidant. In certain embodiments, the coating may include a hydrophobic compound, an adhesion agent, a free-radical initiator, a carrying solvent, and an antioxidant. Moreover, in various embodiments, the coating may include at least one of a hydrophobic compound, an adhesion agent, a shape memory polymer, a free-radical initiator, a carrying solvent, and/or an antioxidant. Exemplary antioxidants that may be used include, but are not limited to, carotenes, xanthophylls, flavonoids, curcuminoids, tocopherols (e.g., vitamin E), phenolic acids, lignins, tannins, or combinations thereof. Other suitable antioxidants that promote the stabilization of the polymer components and/or the polymeric substrate (e.g., ski or snowboard base) are also within the scope of this disclosure.

The coating may also include one or more surfactants. The surfactant may be used to form stable emulsions for hydrophobic compounds that have low or poor solubility in certain carrying solvents. Furthermore, the surfactant may be used to enhance or improve wetting properties of the coating. In some embodiments, the coating may include a hydrophobic compound, a carrying solvent, and a surfactant. In certain embodiments, the coating may include a hydrophobic compound, an adhesion agent, a carrying solvent, and a surfactant. Moreover, in various embodiments, the coating may include at least one of a hydrophobic compound, an adhesion agent, a shape memory polymer, a free-radical initiator, a carrying solvent, an antioxidant, and/or a surfactant. Exemplary surfactants that may be used include, but are not limited to, silicone surfactants, fluorinated surfactants, anionic surfactants, nonionic surfactants, cationic surfactants, zwitterionic surfactants, or combinations thereof. Other suitable surfactants that promote the miscibility of the coating components are also within the scope of this disclosure.

The coating may also include one or more antistatic agents. The antistatic agent may be used to reduce or eliminate a static charge build up along the base of the ski or snowboard. Furthermore, the antistatic agents may be used to enhance or improve conductive properties of the coating. In some embodiments, the coating may include a hydrophobic compound, a carrying solvent, and an antistatic agent. In certain embodiments, the coating may include a hydrophobic compound, an adhesion agent, a carrying solvent, and an antistatic agent. Moreover, in various embodiments, the coating may include at least one of a hydrophobic compound, an adhesion agent, a shape memory polymer, a free-radical initiator, a carrying solvent, an antioxidant, a surfactant and/or an antistatic agent. Exemplary antistatic agents that may be used include, but are not limited to, graphite, graphene, glycols, molybdenum disulfide, or combinations thereof. Other suitable antistatic agents that promote the conductivity of the coating components are also within the scope of this disclosure. The amount of antistatic agents that are present in the coating composition can be between about 0.25 and about 5 weight percent of the coating composition.

An aspect of the disclosure relates to compositions for application to a substrate. Such coating compositions may include one or more of the following: hydrophobic compounds, adhesion agents, shape memory polymers or stabilizers, free-radical initiators, carrying solvents, catalysts, water carrying agents, antioxidants, and surfactants. All combinations and permutations of each of these components disclosed above with respect to ski or snowboard base coating systems may also be present in the coating compositions disclosed herein. Furthermore, all preceding examples of hydrophobic compounds, adhesion agents, shape memory polymers or stabilizers, free-radical initiators, carrying solvents, catalysts, water carrying agents, antioxidants, and surfactants may also be used with the coating compositions contemplated herein. In certain situations, the substrate to which such coating compositions may be applied may also include polymeric substrates.

Methods related to use of the coatings are also disclosed herein. In some embodiments, a method of coating a ski or snowboard may optionally include combining a first hydrophobic compound and a first adhesion agent to form a first liquid mixture. The first liquid mixture can then be obtained by the user, technician, or manufacturer. The method may further include applying the first liquid mixture on at least a portion of a surface of a ski or snowboard to form a first layer. For example, the first liquid mixture can be sprayed and/or spread on at least a portion of a base of the ski or snowboard to form the first layer.

The method of coating the ski or snowboard may also include combining and/or obtaining a first liquid mixture that includes one or more of the following: a first shape memory polymer, a first free-radical initiator, and a first carrying solvent with the first hydrophobic compound and the first adhesion agent. Stated another way, in some embodiments, the first liquid mixture may include a first adhesion agent, a first hydrophobic compound, a first shape memory polymer, a first free-radical initiator, and a first carrying solvent, wherein the constituents are optionally mixed together. Furthermore, the first free-radical initiator may be activated to convert at least a portion of the first liquid mixture to a first interpenetrating polymer network. The first free-radical initiator may also induce chemical bonding of the first adhesion agent to at least a portion of the base of the ski or snowboard (e.g., the UHMWPE surface).

In certain embodiments, the method of coating the ski or snowboard may optionally include combining a second hydrophobic compound and a second adhesion agent to form a second liquid mixture. The second liquid mixture may then be obtained by the user, technician, or manufacturer. The second liquid mixture can be applied (e.g., via spraying, spreading, etc.) on at least a portion of the first layer to form a second layer. The method can also include combining and/or obtaining one or more of the following: a second shape memory polymer, a second free-radical initiator, and a second carrying solvent with the second hydrophobic compound and the second adhesion agent in a second liquid mixture. In other words, in various embodiments, the second liquid mixture can include a second adhesion agent, a second hydrophobic compound, a second shape memory polymer, a second free-radical initiator, and a second carrying solvent. Furthermore, the second free-radical initiator can be activated to convert at least a portion of the second liquid mixture to a second interpenetrating polymer network.

In some embodiments, each of the first and second hydrophobic compounds can include carbon side chains, wherein the length of the carbon side chain of the first hydrophobic compound is greater than the length of the carbon side chain of the second hydrophobic compound.

In various embodiments, the method of coating the ski or snowboard may include combining and/or obtaining a third hydrophobic compound and a third adhesion agent to form a third liquid mixture and applying the third liquid mixture on at least a portion of the second layer to form a third layer. The method may also include combining and/or obtaining one or more of the following: a third shape memory polymer, a third free-radical initiator, and a third carrying solvent with the third hydrophobic compound and the third adhesion agent in a third liquid mixture. Furthermore, the third free-radical initiator may be activated to convert at least a portion of the third liquid mixture to a third interpenetrating polymer network. In certain embodiments, the third hydrophobic compound may include a carbon side chain, wherein the length of the carbon side chain of the third hydrophobic compound is different than the length of the carbon side chains of the first and/or second hydrophobic compounds.

In some embodiments, the method of coating the ski or snowboard may include a free-radical initiated grafting reaction of the first layer, the second layer, the third layer, and/or any additional layers. Stated another way, in certain embodiments, the method of coating the ski or snowboard may include grafting a coating or layer, which has been applied to a portion of a surface of the ski or snowboard. Upon application of the coating or the layer to the surface of the ski or snowboard, the user, technician, or manufacturer may expose the coating or layer to light energy. In various embodiments, the coating may be exposed to light having a wavelength between about 100 nm and about 400 nm. In some embodiments, the coating may be exposed to ultraviolet (UV) light (e.g., UVA, UVB, and/or UVC light), visible light, or combinations thereof.

In certain embodiments, the user, technician, or manufacturer may expose the coating or layer to sunlight for up to about 3 hours, between about 1 and about 3 hours, between about 2 and about 3 hours, or another suitable time period to graft the coating or layer. In certain other embodiments, the user, technician, or manufacturer may expose the coating or layer to UV light, visible light, or a combination thereof in a light box. In comparison to sunlight, it can be faster to graft the coating or layer in a light box. The light box may include or utilize LEDs, or any other suitable light-emitting technology, to provide light energy (e.g., UV light, visible light, etc.). For example, the user, technician, or manufacturer may expose the coating or layer to light energy for up to about 20 minutes, up to about 15 minutes, between about 5 and about 20 minutes, between about 10 and about 20 minutes, between about 15 and about 20 minutes, or another suitable time period. In some other embodiments, the user, technician, or manufacturer may expose the coating or layer to light energy for up to about 5 minutes, less than about 5 minutes, or another suitable time period.

The user, technician, or manufacturer may also expose the coating or layer to heat. In various embodiments, a light box may also provide heat (e.g., in addition to light energy). Heat may facilitate diffusion of the coating compounds into the ski or snowboard base. For example, the user, technician, or manufacturer may expose the coating or layer to heat (e.g., in a light box) between about 70 and about 135 degrees Fahrenheit, between about 70 and about 105 degrees Fahrenheit, or another suitable temperature. The wavelength of light and/or the amount of heat may be modified by the user, technician, or manufacturer according to the composition of the coating, the composition of the ski or snowboard, weather and/or snow conditions, or any other relevant variable. In certain embodiments, the user, technician, or manufacturer may expose the coating or layer to a pre-heating cycle outside of the light box. A heating tool (e.g., heat gun) may be used for the pre-heating cycle.

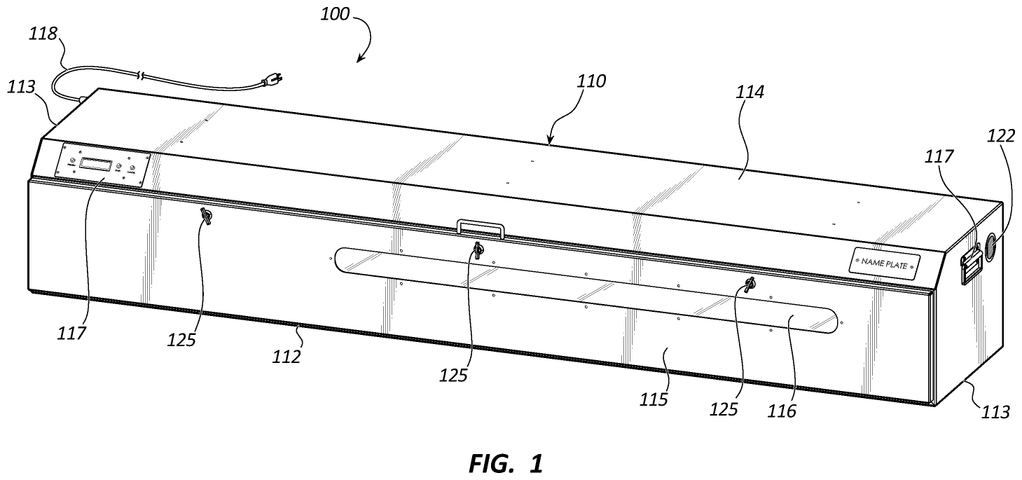

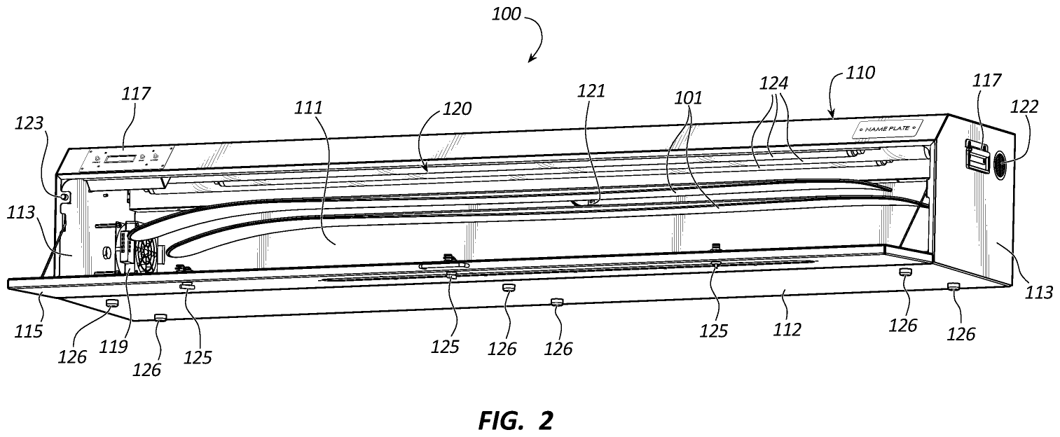

FIGS. 1 and 2 illustrate a light-generating receptacle or light box 100 configured to be used by a user, technician, or manufacturer to initiate a free-radical initiated grafting reaction of the coating or layer to a surface of a ski or snowboard 101. The light box 100 may expose the coating or layer to light energy and/or heat. As illustrated, the light box 100 comprises a cabinet 110 having a baseplate 112, end plates 113, a top 114, and a door 115. The cabinet 110 defines a chamber 111. The cabinet 110 may be sized to accommodate at least one ski or snowboard 101, at least two skis or snowboards 101, or at least three or more skis or snowboards 101. The cabinet 110 may be formed from any suitable rigid material. For example, the cabinet 110 may be formed from steel, aluminum, galvanized metal, etc. The base plate 112, the end plates 113 and the top 114 may be formed as an integral unit. In some embodiments, the base plate 112, the end plates 113, and the top 114 may be formed as separate components and joined together using weld joints, rivets, bolts, or any other suitable technique known in the art. A plurality of bumpers 126 may be coupled to the baseplate 112. The bumpers 126 may stabilize the light box 100 when disposed on a counter top or bench top. Handles 117 may be coupled to the end plates 113 to facilitate transporting the light box 100 from a first location to a second location. Vents 122 may be disposed in the end plates 113 to facilitate ventilation of the chamber 111. The vents 122 may comprise louvers.

In some embodiments, the door 115 may be hingedly coupled to the base plate 112 to facilitate selective opening and closing of the door 115. The door 115 may be opened to allow for placement of a ski or snowboard 101 within the chamber 111. The door 115 may include a window 116 to permit observation of a ski or snowboard 101 disposed within the chamber 111 without opening the door 115. The window 116 may be formed from a transparent material that filters UV light to protect the user, technician, or manufacturer from inadvertent exposure to UV light. The door 115 may include at least one latch 125 to secure the door 115 in a closed state. A switch 123 may be coupled to the cabinet 110. The switch 123 may be configured to allow power to flow to a controller 117 when the door 115 is closed and the switch 123 is depressed and to prevent power from flowing to the controller 117 when the door 115 is open and the switch 123 is not depressed. In other words, the switch 123 may be a safety mechanism to prevent inadvertent exposure of the user, technician, or manufacture to harmful UV light energy or high temperature.

In certain embodiments, the light box 100 may include the controller 117, a power input 118, a heater 119, and a light energy source 120. As shown in FIGS. 1 and 2, the controller 117 may be coupled to the cabinet 110. The controller 117 may be electrically coupled to the power input 118 through the switch 123, a heater 119, a light energy source 120, and a temperature sensor 121. The controller 117 may include a digital display and operable buttons, dials, or switches configured to preheat the chamber 111, to initiate a polymerization cycle, to cancel a polymerization cycle, or to adjust any other polymerization cycle parameter. The controller 117 may be configured to control the heater 119 to achieve a desired curing temperature. The digital display may display a chamber temperature as measured by the temperature sensor 121, polymerization cycle time, or any other polymerization cycle parameter. The controller 117 may control power to the light energy source 120. In other words, the controller may allow power to flow to and prevent power from flowing to the light energy source 120. The controller 117 may control a wavelength and/or intensity output of the light energy source 120. The controller 117 may be configured to manually or automatically (e.g., using programmable software) control the heater 119 and light energy source 120 to achieve the desired grafting reaction parameters. A power cord may be coupled to the power input 118. The power cord may be plugged into a wall outlet. In another embodiment, the power input 118 may be coupled to a rechargeable of replaceable battery power source.

With continued reference to FIG. 2, the light energy source 120 may include at least one light bulb 124 capable of emitting light energy having wavelengths as previously discussed. In other embodiments, the light energy source 120 may include two, three, four, or more light bulbs 124. In one embodiment, the bulb acts as a housing for UV-emitting LEDs. The light bulb 124 may be disposed adjacent an upper portion of the chamber 111 such that the light bulb 124 is disposed over the ski or snowboard 101 to facilitate exposure of the coating or layer on the surface of the ski or snowboard 101 to the light energy. In another embodiment, additional light bulbs 124 may be disposed over and to the side of the ski or snowboard 101 such that exposure to the light energy may be maximized.

In use, the light box 100 may be positioned on a counter top or workbench top. The light box 100 may be coupled to a power source. The user, technician, or manufacturer may unlatch and open the door 115. At least one ski or snowboard 101 which has a surface treated with the coating or layer may be positioned within the chamber 111 such that the coating or layer is oriented toward the light energy source 120. The ski or snowboard 101 may be disposed on a holding fixture (not shown) to maintain the orientation of the coating or layer. The door 115 may be closed and locked utilizing the latch 125. Upon closing of the door 115, the switch 123 may be activated to permit power to flow to the controller 117. The user, technician, or manufacturer may activate the polymerization cycle using the controller 117. In other embodiments, the user, technician, or manufacturer may select a polymerization cycle program using the controller 117 prior to activation of the polymerization cycle. Upon completion of the polymerization cycle, which may include a cool down period of time, the door 115 may be unlatched and opened such that the ski or snowboard 101 may be removed from the light box 100.

In some embodiments, a method of coating a ski or snowboard may optionally include combining an adhesion agent and a free-radical initiator to form a first liquid mixture. The first liquid mixture can then be obtained by the user, technician, or manufacturer. The method may further include applying the first liquid mixture on at least a portion of a surface of a ski or snowboard to form a first layer. For example, the first liquid mixture can be sprayed and/or spread on at least a portion of a base of the ski or snowboard to form the first layer.

The method of coating the ski or snowboard may also include combining and/or obtaining a first liquid mixture that includes one or more of the following: an adhesion agent and a free-radical initiator with a hydrophobic compound, a shape memory polymer, and a carrying solvent. Stated another way, in some embodiments, the first liquid mixture may include an adhesion agent, a hydrophobic compound, a free-radical initiator, a shape memory polymer, and a carrying solvent, wherein the constituents are optionally mixed together. Furthermore, the first layer may be light polymerized as described above.

In some embodiments, the method of coating a ski or snowboard may optionally include combining an adhesion agent and a free-radical initiator to form a second liquid mixture. The second liquid mixture can then be obtained by the user, technician, or manufacturer. The method can further include applying the second liquid mixture on at least a portion of a surface of the first layer to form a second layer. For example, the second liquid mixture can be sprayed and/or spread on at least a portion of a base of the first layer to form the second layer.

The method of coating the ski or snowboard may also include combining and/or obtaining a second liquid mixture that includes one or more of the following: an adhesion agent and a free-radical initiator with a hydrophobic compound, a shape memory polymer, and a carrying solvent. Stated another way, in some embodiments, the second liquid mixture may include an adhesion agent, a hydrophobic compound, a free-radical initiator, a shape memory polymer, and a carrying solvent, wherein the constituents are optionally mixed together. Furthermore, the second layer may also be light polymerized as described above.

In some embodiments, a method of coating a ski or snowboard may optionally include combining an adhesion agent and a free-radical initiator to form a first liquid mixture. The first liquid mixture can then be obtained by the user, technician, or manufacturer. The method may further include applying the first liquid mixture on at least a portion of a surface of a ski or snowboard to form a first layer. For example, the first liquid mixture can be sprayed and/or spread on at least a portion of a base of the ski or snowboard to form the first layer.

The method of coating the ski or snowboard may also include combining and/or obtaining a first liquid mixture that includes one or more of the following: a shape memory polymer and a carrying solvent with the adhesion agent and the free-radical initiator. Stated another way, in some embodiments, the first liquid mixture may include an adhesion agent, a free-radical initiator, a shape memory polymer, and a carrying solvent, wherein the constituents are optionally mixed together. Furthermore, the first layer may be light polymerized as described above.

In certain embodiments, the method of coating a ski or snowboard may optionally include obtaining a hydrophobic compound or second liquid mixture including the hydrophobic compound. The hydrophobic compound or the second liquid mixture can then be obtained by the user, technician, or manufacturer. The method can further include applying the hydrophobic compound on at least a portion of a surface of the first layer to form a second layer. For example, the hydrophobic compound can be sprayed and/or spread on at least a portion of a surface of the first layer to form the second layer.

The method of coating the ski or snowboard may also include combining and/or obtaining a second liquid mixture that includes one or more of the following: a shape memory polymer and a carrying solvent with the hydrophobic compound. Stated another way, in some embodiments, the second liquid mixture may include a hydrophobic compound, a shape memory polymer, and a carrying solvent, wherein the constituents are optionally mixed together. In some embodiments, the second liquid mixture may include the shape memory polymer and/or the carrying solvent. In some other embodiments, the second liquid mixture may include the shape memory polymer and/or the carrying solvent. In yet other embodiments, both the first liquid mixture and the second liquid mixture may include the shape memory polymer and/or the carrying solvent. Additionally, the second layer may be moisture cured or water cured. As discussed above, one or more catalysts may be used to accelerate the process of moisture curing. Water carrying agents may also be used to aid the moisture curing process.

In certain embodiments, the method of coating the ski or snowboard may optionally include obtaining a catalyst or a third liquid mixture including the catalyst. The catalyst or the third liquid mixture can then be obtained by the user, technician, or manufacturer. The method can further include applying the catalyst on at least a portion of the second layer. In some embodiments, the third liquid mixture can promote the polymerization of the hydrophobic compound. For example, the hydrophobic compound may include fluorinated silanes, and the catalyst may promote the polymerization of the fluorinated silanes to fluorinated silicones. Such a configuration can decouple or separate the catalyst from the first and/or second liquid mixtures, for example, if there are difficulties in generating a stable solution that includes both the catalyst and the adhesion agent, hydrophobic compound, shape memory polymer, free-radical initiator, and/or carrying solvent. In some embodiments, the third liquid mixture may also include a pH modifier and/or a surfactant. Application of the third liquid mixture to the second layer may be a final step that can induce conversion of the fluorinated silanes to fluorinated silicones. In certain embodiments, the conversion of the fluorinated silanes to fluorinated silicones may be quick or rapid.

Application of a liquid mixture including a catalyst as described above may be incorporated into any of the methods provided herein. For example, upon application of liquid mixture including a hydrophobic compound (e.g., a fluorinated silane) to form a layer, a liquid mixture including a catalyst may then be applied (e.g., as a second liquid mixture, a third liquid mixture, a fourth liquid mixture, etc.) to the layer including the hydrophobic compound.

Each of the hydrophobic compounds (e.g., the first hydrophobic compound, the second hydrophobic compound, and the third hydrophobic compound) may be independently selected from at least one of a fluorinated silane, a fluorinated hydrocarbon, a fluorinated polymer, a fluorinated silicone, or a hydrophobic silane. For example, the first hydrophobic compound may be a fluorinated silicone, the second hydrophobic compound may be a fluorinated ethylene propylene (or other fluorinated polymer), and the third hydrophobic compound may be a fluorinated silane, or other iterations and permutations.

Each of the adhesion agents (e.g., the first adhesion agent, the second adhesion agent, and the third adhesion agent) may be independently selected from at least one of an organosilane, hexachlorodisilane, poly(4-vinylphenol), a polyacrylic acid, a titanate, or a zirconate. For example, the first adhesion agent may be an organosilane, the second adhesion agent may be a hexachlorodisilane, and the third adhesion agent may be a polyacrylic acid, or other iterations and permutations.

Each of the shape memory polymers (e.g., the first shape memory polymer, the second shape memory polymer, and the third shape memory polymer) may be independently selected from at least one of ε-caprolactone, polycaprolactone (PCL), polynorbomene, a polyene, a nylon, polycyclooctene (PCO), polyvinyl acetate/polyvinylidene fluoride (PVAc/PVDF), a PVAc/PVDF/poly-methylmethacrylate (PMMA) blend, a polyurethane, a styrene-butadiene copolymer, polyethylene (PE), trans-isoprene, or polyvinyl chloride (PVC). For example, the first shape memory polymer may be PCO and each of the second and third shape memory polymers may be polyurethanes, or other iterations and permutations.

Each of the free-radical initiators (e.g., the first free-radical initiator, the second free-radical initiator, and the third free-radical initiator) may be independently selected from at least one of a photoinitiator, a thermal initiator, or a chemical catalyst. For example, the first free-radical initiator may be a photoinitiator, the second free-radical initiator may be a chemical catalyst, and the third free-radical initiator may be a thermal initiator, or other iterations and permutations. Exemplary photoinitiators are described above.

Furthermore, each of the carrying solvents (e.g., the first carrying solvent, the second carrying solvent, and the third carrying solvent) may be independently selected from at least one of water, methanol, ethanol, ethylene glycol, propylene glycol, a polyol, a polar aprotic solvent, a hydrocarbon solvent, an amine-based solvent, a non-polar solvent (e.g., anisole), or other suitable carrying solvent that promotes the miscibility of the polymer coating components and the polymeric substrate (of the ski or snowboard). For example, the first carrying solvent and the second carrying solvent may be ethanol and the third carrying solvent may be ethylene glycol, or other iterations and permutations.

In certain embodiments, the coating can include one or more hydrophobic compounds, adhesion agents, shape memory polymers, free-radical initiators, carrying solvents, catalysts, water carrying agents, antioxidants, and/or surfactants in a single mixture that can be later applied to at least a portion of a surface of a ski or snowboard by a user, technician, or manufacturer. Additionally, components of the coating may be applied successively. Alternatively, subcombinations of the coating can be applied simultaneously while other components are applied successively/serially. For example, a solution comprising an adhesion agent may be applied initially to a surface of a ski or snowboard followed within a few minutes by a solution comprising a hydrophobic compound. After a period of time to allow for the two solutions to soak together, the solutions could be exposed to light energy. In certain other embodiments, the coating can be applied to at least a portion of the surface of the ski or snowboard in two or more layers. For example, a first mixture including a first adhesion agent, a first hydrophobic compound, a first shape memory polymer, a first free-radical initiator, and a first carrying solvent can be applied to at least a portion of the surface of a ski or snowboard and a first interpenetrating polymer network can be formed. A second mixture including a second adhesion agent, a second hydrophobic compound, a second shape memory polymer, a second free-radical initiator, and a second carrying solvent can then be applied to at least a portion of the first layer and a second interpenetrating polymer network can be formed. In various embodiments, the first hydrophobic compound may include a longer carbon side chain than the second hydrophobic compound. The layering process described above and/or additional mixtures (e.g., a third mixture including a third hydrophobic compound) may be used to form additional layers.

The various mixtures (e.g., the first mixture, the second mixture, etc.) can begin in a liquid form that may allow for penetration and/or saturation of the coating into a porous (or micro- or nano-porous) surface of a ski or snowboard (e.g., a porous base of the ski or snowboard). In some embodiments, the liquid mixtures may allow for full, or substantially full, penetration and/or saturation of the coating into a porous surface of a ski or snowboard.

In certain embodiments, wherein the free-radical initiator is a photoinitiator, upon the application of light energy (e.g., UV light) the photoinitiator may initiate a free-radical initiated grafting process to permanently, or semi-permanently, associate the coating with the base substrate. By using a liquid form of the various mixtures to achieve full, or substantially full, saturation of the coating into the base material and then inducing polymerization within the liquid mixtures, a polymer network can be formed that fills or penetrates a greater portion of a ski or snowboard base than traditional waxes or other coatings.

The use of an adhesion agent, as discussed above, can result in the formation of a permanent, or semi-permanent, association between the hydrophobic compound and the ski or snowboard base. Additionally, the adhesion agent may result in the formation of a stronger association between the base material and the hydrophobic compound as compared to traditional waxes and some other coatings. Filling the pores of a ski or snowboard surface with a polymer coating or system as provided herein, which incorporates hydrophobic compounds, can impart the surface of the ski or snowboard with enhanced durability and/or permanent, or substantially permanent, enhanced lubricity.

The lubricious coating system provided herein does not include wax or waxy components. In contrast to a wax or wax-like treatment, the lubricious coating system includes an interpenetrating polymer network that is absorbed into the material of the ski or snowboard and then bonded to the material of the ski or snowboard via a free-radical initiated grafting method. Furthermore, the lubricious coating system is chemically bound (e.g., via the free radical initiators and the adhesion agent) to the surface of the ski or snowboard. As can be appreciated, additional methods and/or method steps can be derived from the present disclosure.

References to approximations are made throughout this specification, such as by use of the term “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially full” is recited with respect to a feature, it is understood that in further embodiments, the feature can have a precisely full configuration.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A ski or snowboard base-coating system, comprising:
a lubricious coating composition, comprising:
a hydrophobic compound; and
a free-radical initiator configured to facilitate grafting of the hydrophobic compound to the ski or snowboard base; and
a light-generating receptacle, comprising:
a light energy source; and
a chamber configured for exposing the ski or snowboard base coated with the lubricious coating composition to the light energy source.

2. The coating system of claim 1, wherein the coating composition further comprises an adhesion agent configured to promote adhesion of the hydrophobic compound to the ski or snowboard base.

3. The coating system of claim 1 or 2, wherein the hydrophobic compound is selected from at least one of a fluorinated silane, a fluorinated hydrocarbon, a fluorinated polymer, a fluorinated silicone or a non-fluorinated silane.

4. The coating system of any one of claims 1-3, wherein the lubricious coating composition further comprises a shape memory polymer.

5. The coating system of any one of claims 1-4, wherein the free-radical initiator comprises a photo-initiator.

6. The coating system of any one of claims 1-5, wherein the lubricious coating composition further comprises a carrying solvent.

7. The coating system of any one of claims 1-6, wherein the light-generating receptacle comprises:
a chamber configured for housing a ski or snowboard; and
a controller for controlling the exposure of the ski or snowboard base to light energy.

8. The coating system of any one of claims 1-7, wherein the light energy source generates UV light.

9. The coating system of claim 8, wherein the UV light includes a wavelength of between 100 nm and 400 nm.

10. The coating system of any one of claims 7-9, wherein the controller controls an intensity and a wavelength of the light energy source.

11. The coating system of any one of claims 1-10, wherein the light-generating receptacle further comprises a heater configured to expose the ski or snowboard base coated with the lubricious coating composition to a temperature of between 70 degrees Fahrenheit and 135 degrees Fahrenheit.

12. A lubricious coating system for application to a ski or snowboard, comprising:
a hydrophobic compound; and
an adhesion agent configured to promote adhesion of the hydrophobic compound to a ski or snowboard base.

13. The lubricious coating system of claim 12, wherein the hydrophobic compound is present in an amount of between 0.1 and 15 weight percent and the adhesion agent is present in an amount of between 0.1 and 15 weight percent of the coating system.

14. The lubricious coating system of claim 12 or 13, wherein the adhesion agent is selected from at least one of an organosilane, hexachlorodisilane, poly(4-vinylphenol), a polyacrylic acid, a titanate, or a zirconate.

15. The lubricious coating system of claim 14, wherein the adhesion agent is an organosilane selected from at least one of vinyltrimethoxysilane, (3-aminopropyl)triethoxysilane, methyltrichlorosilane, triethoxymethylsilane, trimethoxymethylsilane, dimethoxydimethylsilane, methoxytrimethylsilane, diethoxydimethylsilane, triethoxyvinylsilane, trichlorovinylsilane, methyldiethoxysilane, triethoxy(ethyl)silane, ethoxytrimethylsilane, dimethoxyvinylsilane, ted-butyltrichlorosilane, (chloromethyl)triethoxysilane, bis(trichlorosilyl) methane, 1,2-bis(triethoxysilyl)ethane, 1,2-bis(trimethoxysilyl)ethane, 1,2-bis(trichlorosilyl)ethane, trichloro(dichloromethyl)silane, diethoxy(methyl)vinylsilane, or 1,3-diethoxy-1,1,3,3-tetramethyldisiloxane.

16. The lubricious coating system of any one of claims 12-15, wherein the hydrophobic compound is selected from at least one of a fluorinated silane, a fluorinated hydrocarbon, a fluorinated polymer, a fluorinated silicone or a non-fluorinated silane.

17. The lubricious coating system of claim 16, wherein the hydrophobic compound comprises a fluorinated silane that includes a carbon side chain, and wherein a length of the carbon side chain of the fluorinated silane is between 1 and 30 carbons.

18. The lubricious coating system of claim 16, wherein the hydrophobic compound comprises a first fluorinated silane including a first carbon side chain and a second fluorinated silane including a second carbon side chain, and wherein the length of the first carbon side chain of the first fluorinated silane is greater than the length of the second carbon side chain of the second fluorinated silane.

19. The lubricious coating system of claim 18, wherein the first carbon side chain has between 9 and 30 carbons and the second carbon side chain has between 1 and 8 carbons.

20. The lubricious coating system of claim 16, wherein the hydrophobic compound comprises a fluorinated polymer that is at least one of polytetrafluoroethylene (PTFE) or fluorinated ethylene propylene (FEP).

21. The lubricious coating system of claim 16, wherein the non-fluorinated silane is selected from at least one of methylated silane, methyl-siloxanyl silane, linear alkyl silane, dialkyl silane, branched alkyl silane, cyclic alkyl silane, phenyl silane, phenyl alkyl silane, substituted phenyl silane, substituted phenylalkyl silane, or napthyl-silane.

22. The lubricious coating system of any one of claims 12-21, further comprising a shape memory polymer.

23. The lubricious coating system of claim 22, wherein the shape memory polymer is present in an amount of between 1.0 and 10 weight percent of the coating system.

24. The lubricious coating system of claim 22 or 23, wherein the shape memory polymer is selected from at least one of ε-caprolactone, polycaprolactone (PCL), polynorbomene, a polyene, a nylon, polycyclooctene (PCO), polyvinyl acetate/polyvinylidene fluoride (PVAc/PVDF), a PVAc/PVDF/poly-methylmethacrylate (PMMA) blend, a polyurethane, a styrene-butadiene copolymer, polyethylene (PE), trans-isoprene, or polyvinyl chloride (PVC).

25. The lubricious coating system of any one of claims 12-24, further comprising a free-radical initiator.

26. The lubricious coating system of claim 25, wherein the free-radical initiator is present in an amount of between 0.01 and 10 weight percent of the coating system.

27. The lubricious coating system of claim 25 or 26, wherein the free-radical initiator is selected from at least one of a photoinitiator, a thermal initiator, or a chemical catalyst.

28. The lubricious coating system of claim 27, wherein the free radical initiator comprises the photoinitiator selected from at least one of acetophenone, anisoin, anthraquinone, anthraquinone-2-sulfonic acid, (benzene)tricarbonylchromium, benzil, benzoin, benzoin ethyl ether, benzoin isobutyl ether, benzoin methyl ether, benzophenone, benzophenone/1-hydroxycyclohexyl phenyl ketone, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(II) hexafluorophosphate, dibenzosuberenone, 2,2-diethoxyacetophenone, 4,4′ dihydroxybenzophenone, dimethoxyacetophenone, 2,2-dimethoxy-2-phenylacetophenone (DMPAP), 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 4′-ethoxyacetophenone, 2-ethylanthraquinone, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, phenylbis (2,4,6-trimethylbenzoyl)-phosphine oxide (BAPO), thioxanthen-9-one, triarylsulfonium hexafluoroantimonate salts, thioxanthone, triarylsulfonium hexafluorophosphate salts, or xanthone.

29. The lubricious coating system of any one of claims 12-28, further comprising a carrying solvent.

30. The lubricious coating system of claim 29, wherein the carrying solvent is present in an amount of between 25 and 95 weight percent of the coating system.

31. The lubricious coating system of claim 29 or 30, wherein the carrying solvent is selected from at least one of water, methanol, ethanol, ethylene glycol, propylene glycol, a polyol, a polar aprotic solvent, a hydrocarbon solvent, an amine-based solvent, or a non-polar solvent.

32. The lubricious coating system of any one of claims 12-31, wherein the coating system is free of wax.

33. A method of coating a ski or snowboard, the method comprising:
obtaining a liquid mixture comprising a hydrophobic compound and an adhesion agent; and
applying the liquid mixture on a portion of a surface of a base of a ski or snowboard to form a layer.

34. The method of claim 33, wherein applying the liquid mixture comprises applying the first liquid mixture to a ski or snowboard base comprising ultra-high molecular weight polyethylene.

35. The method of claim 33 or 34, wherein the liquid mixture further comprises a shape memory polymer, a free-radical initiator, and a carrying solvent.

36. The method of claim 35, further comprising:
mixing the hydrophobic compound, the adhesion agent, the shape memory polymer, the free-radical initiator, and the carrying solvent to form the liquid mixture.

37. The method of claim 35 or 36, further comprising:
activating the free-radical initiator to convert a portion of the liquid mixture to an interpenetrating polymer network.

38. A coating composition for application to a substrate, comprising:
a hydrophobic compound;
an adhesion agent configured to promote the adhesion of the hydrophobic compound to the substrate;
a shape memory polymer;
a free-radical initiator; and
a carrying solvent.

39. The coating composition of claim 38, wherein the hydrophobic compound is present in an amount of between 1.0 and 15 weight percent, the adhesion agent is present in an amount of between 1.5 and 15 weight percent, the shape memory polymer is present in an amount of between 1.0 and 10 weight percent, the free-radical initiator is present in an amount of between 0.01 and 10 weight percent, and the carrying solvent is present in an amount of between 25 and 95 weight percent.

40. The coating composition of claim 38 or 39, wherein the hydrophobic compound is selected from at least one of a fluorinated silane, a fluorinated hydrocarbon, a fluorinated polymer, a fluorinated silicone, or a non-fluorinated silane.

41. The coating composition of claim 40, wherein the hydrophobic compound comprises the fluorinated silane that includes a fluorinated carbon side chain, and wherein a length of the carbon side chain of the fluorinated silane is between 1 and 30 carbons.

42. The coating composition of claim 41, wherein the hydrophobic compound comprises a first fluorinated silane including a first fluorinated carbon side chain having a length of between 9 and 30 carbons and a second fluorinated silane including a second fluorinated carbon side chain with a length of between 1 and 8 carbons.

43. The coating composition of claim 40, wherein the fluorinated compound comprises a fluorinated polymer that is at least one of polytetrafluoroethylene (PTFE) or fluorinated ethylene propylene (FEP).

44. The coating composition of claim 40, wherein the non-fluorinated silane is selected from at least one of methylated silane, methyl-siloxanyl silane, linear alkyl silane, dialkyl silane, branched alkyl silane, cyclic alkyl silane, phenyl silane, phenyl alkyl silane, substituted phenyl silane, substituted phenylalkyl silane, or napthyl-silane.

45. The coating composition of any one of claims 38-44, wherein the adhesion agent is selected from at least one of an organosilane, hexachlorodisilane, poly(4-vinylphenol), a polyacrylic acid, a titanate, or a zirconate.

46. The coating composition of claim 45, wherein the adhesion agent is an organosilane selected from at least one of vinyltrimethoxysilane, (3-aminopropyl)triethoxysilane, methyltrichlorosilane, triethoxymethylsilane, trimethoxymethylsilane, dimethoxydimethylsilane, methoxytrimethylsilane, diethoxydimethylsilane, triethoxyvinylsilane, trichlorovinylsilane, methyldiethoxysilane, triethoxy(ethyl)silane, ethoxytrimethylsilane, dimethoxyvinylsilane, tert-butyltrichlorosilane, (chloromethyl)triethoxysilane, bis(trichlorosilyl)methane, 1,2-bis(triethoxysilyl)ethane, 1,2-bis(trimethoxysilyl)ethane, 1,2-bis(trichlorosilyl)ethane, trichloro(dichloromethyl)silane, diethoxy(methyl)vinylsilane, or 1,3-diethoxy-1,1,3,3-tetramethyldisiloxane.

47. The coating composition of any one of claims 38-46, wherein the shape memory polymer is selected from at least one of ε-caprolactone, polycaprolactone (PCL), polynorbomene, a polyene, a nylon, polycyclooctene (PCO), polyvinyl acetate/polyvinylidene fluoride (PVAc/PVDF), a PVAc/PVDF/poly-methylmethacrylate (PMMA) blend, a polyurethane, a styrene-butadiene copolymer, polyethylene (PE), trans-isoprene, or polyvinyl chloride (PVC).

48. The coating composition of any one of claims 38-47, wherein the free-radical initiator is selected from at least one of a photoinitiator, a thermal initiator, or a chemical catalyst.

49. The coating composition of claim 48, wherein the free radical initiator comprises a photoinitiator selected from at least one of acetophenone, anisoin, anthraquinone, anthraquinone-2-sulfonic acid, (benzene)tricarbonylchromium, benzil, benzoin, benzoin ethyl ether, benzoin isobutyl ether, benzoin methyl ether, benzophenone, benzophenone/1-hydroxycyclohexyl phenyl ketone, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(II) hexafluorophosphate, dibenzosuberenone, 2,2-diethoxyacetophenone, 4,4′ dihydroxybenzophenone, dimethoxyacetophenone, 2,2-dimethoxy-2-phenylacetophenone (DMPAP), 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 4′-ethoxyacetophenone, 2-ethylanthraquinone, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, phenylbis (2,4,6-trimethylbenzoyl)-phosphine oxide (BAPO), thioxanthen-9-one, triarylsulfonium hexafluoroantimonate salts, thioxanthone, triarylsulfonium hexafluorophosphate salts, or xanthone.

50. The coating composition of any one of claims 38-49, wherein the carrying solvent is selected from at least one of water, methanol, ethanol, ethylene glycol, propylene glycol, a polyol, a polar aprotic solvent, a hydrocarbon solvent, an amine-based solvent, or a non-polar solvent.

51. The coating composition of any one of claims 38-50, wherein the coating system is free of wax.

52. A method of making a ski or snowboard base lubricious, comprising:
obtaining a lubricious liquid;
applying the lubricous liquid to the ski or snowboard base; and
exposing the lubricious liquid to light energy.

53. The method of claim 52, wherein the exposing the lubricious liquid to light energy comprises:
obtaining a light box, wherein the light box comprises:
a cabinet defining a chamber;
a controller; and
a light energy source; and
disposing the ski or snowboard within the chamber.

54. The method of claim 53, wherein the light energy source generates UV light.

55. The method of claim 52 or 53, wherein the controller controls an intensity and a wavelength of the light energy source.

56. The method of claim 55, wherein the UV light includes a wavelength of between 100 nm and 400 nm.

57. The method of any one of claims 52-56 further comprising:
exposing the lubricious liquid to heat.

58. The method of any of claims 53-57, wherein the light box further comprises a heater.

59. The method of claim 57, wherein exposing the lubricious liquid to heat comprises:
exposing the lubricious coating to a temperature of between 70 degrees Fahrenheit and 135 degrees Fahrenheit.

60. The method of any one of claims 53-59, wherein the light box further comprises a temperature sensor that is coupled to the controller.

61. The method of any one of claims 58-60, wherein the controller controls the heater.

62. The method of any one of claims 52-61 further comprising:
bonding the lubricious coating to the ski or snowboard base.

63. The method of claim 62, wherein bonding the lubricious coating comprises:
initiating a free-radical grafting process, wherein the lubricious liquid is grafted to the ski or snowboard base.
